(19) United States
(12) Patent Application Publication
(10) Pub. No.: US 2008/0304525 A1
(43) Pub. Date: Dec. 11, 2008

(54) Method for Internal Laser Marking in Transparent Materials and Device for Implementing Said Method

(76) Inventors: Axel Kupisiewicz, Tilff (BE); Eric Mottay, Begles (FR)

Correspondence Address: BACON & THOMAS, PLLC, 625 SLATERS LANE, FOURTH FLOOR, ALEXANDRIA, VA, 22314-1176, US

(21) Appl. No.: 11/992,299

(22) PCT Filed: Sep. 22, 2006
(86) PCT No.: PCT/BE2006/000105

§ 371 Date: Mar. 20, 2008

(30) Foreign Application Priority Data
Sep. 22, 2005 (BE) 2005/0463

(51) Int. Cl. H01S 3/13; B41J 2/47

(52) U.S. Cl. 372/30; 347/225

(57) ABSTRACT

The invention concerns a method for internal laser marking in transparent materials, for example for marking an identifier (5) for an object made of transparent material (6). The invention is characterized in that a diode-pumped femtosecond laser source (1) is used for non-aggressive high-contrast marking to generate laser pulses (13) which are successively focused on different points (23) of the marking (5) to be produced and enabling high-speed marking operations, typically faster than 0.1 mm2 per second to be performed.

The invention concerns an industrial process for the internal laser marking of transparent materials.

Laser marking is a key method in the identification, traceability and prevention of product counterfeiting.

For transparent materials, the present laser technologies (YAG ns—Yttrium Aluminum Garnet) do not meet the industrial requirements. A recently developed laser technology, called Ti:Sa, on the basis of Titanium ion doped sapphire crystals, showed promising results for the engraving of materials by means of femtosecond pulses, i.e. pulses in the order of 10-¹⁵ seconds, for the creation of a waveguide, but its industrial development still encounters major difficulties related to production speed, reliability, price, etc., as well as lifetime of the marks.

As of the 90's, YAG lasers have been increasingly used in industry so as to replace labels and ink prints on opaque materials such as metals and plastics. Said lasers can be used continuously (CW) or in trigger mode (Q-Switch) so as to create long high-frequency pulses. They make use of thermal phenomena to remove the material by engraving the surface or to change the color of the surface of the material, which is called “thermal-direct” marking.

Unfortunately, the wavelengths of the industrial YAG lasers are situated in the visible or near-infrared field and cannot efficiently interact with transparent materials in order to obtain thermal phenomena such as on opaque materials. Hence, they are not appropriate for transparent elements.

In order to engrave transparent materials, C02 lasers are used as their wavelength of 10.6 μm allows for the absorption of energy on the surface of the glass.

However, these lasers offer major problems:
material ablation on the surface of the material embrittles the product, as a result of which they cannot be used for a whole range of applications;
as engraved codes are situated on the surface, they can be altered by other treatments during production or transport, or they can be erased on purpose to avoid anti-fraud protection and controls; and,
because of the high wavelength and thermal damages, the resolution is very low, such that the codes will have to be very large, as a result of which it is impossible to provide invisible anti-fraud codes.

At the end of the nineties, the development of YAG lasers with shorts pulses of some 10 ns made it possible to create micro cracks inside materials by focusing the concentrated energy in a single point. This considerably dense energy within a very short time span exceeds the threshold of material damages and results in the creation of micro cracks with a diameter of 50 to 100 μm inside the glass. This technology makes it possible to engrave 3D shapes in the glass or PMMA, based on a series of micro cracks.

However, the resulting engravings have the following major restrictions for many industrial applications such as glass decoration, antifraud engraving or normative marking:
the treatment is not feasible for very fine materials or materials that are subject to internal or external constraints, as the pulse length is long enough to produce thermal effects and cracks, which may in turn embrittle the material, which is absolutely prohibited in the chemical and pharmaceutical industry (class 1 glass) and which is to be avoided for other glass containers such as perfume or wine bottles for example, which are subject to considerable constraints during transport, such as temperature variations, vibrations and shocks, which would critically increase the micro cracks and would probably result in the bottle being broken;
the engravings are considerably large, which is disadvantageous in that the bar codes must be considerably large, i.e. a few square millimeters, in order to be able to contain legible information;
for antifraud and normative applications, the contrasts of the resulting engravings require the implementation of sophisticated viewing systems and a special lighting to read the engraved signatures, given their restricted resulting contrast of less than 30%;
the engraving of complex shapes requires thousands of “micro points” per cm³, leading to treatment times of several tenths of seconds, as the pulsed YAG lasers have a pulse frequency between 500 and 2000 hertz, which has for a result that the internal decoration productivity with these YAG lasers is still low for the glass decoration industry; and,
for decoration and antifraud or normative marking applications, the quality of the engraving is influenced by the quality fluctuations of the treated glass, which has for a result that laser/glass interactions with such flaws may lead to illegible marks and marks of bad quality.

The following table gives an overview of the present laser techniques.

| Laser | Type of | |
|---|---|---|
| technology | method | Restrictions |
| C02 CW OR QCW | Surface | Embrittles the material, very low [symbol] |
| | engraving | resolution, can be altered or [symbol] |
| | | erased |
| YAG CW OR QCW | Surface | Not appropriate for transparent [symbol] |
| | engraving | materials |
| pulsed YAG (ns) | Internal | Embrittles the material, low [symbol] |
| | engraving | resolution, not fast enough, to [symbol] |
| | | dependant of the material quality, [symbol] |
| | | requires a very expensive viewing [symbol] |
| | | system |

[symbol]

indicates data missing or illegible when filed

Until the beginning of the nineties, ultra rapid lasers, also called femtoseconds with a pulse length of less than one picosecond, i.e. 10-¹² second, were sophisticated but fragile laboratory lasers which had to be operated by highly qualified scientists.

A first generation of ultra rapid commercial lasers, making use of a titanium-doped sapphire (Ti:Sapphire) as an active material, was introduced in the beginning of the nineties, enabling other researchers from different fields such as biology, chemistry, spectroscopy, to take advantage of the very short pulse length. It enabled them to obtain innovating results of a superior scientific quality. For example, the Nobel prize for chemistry was granted to Pr. Ahmed Zewail from Stanford University in 1999 for his research in the field of “femtochemistry”, less than 10 years after the first femtosecond laser had been commercialized.

This first generation of femtosecond lasers, although perfectly adapted to a research environment, represents restrictions which prevent it from being used in an industrial environment.

Due to the spectroscopic structure of the Ti:Sapphire, one or several additional intermediary lasers are required in a femtosecond Ti:Sapphire laser. These intermediary lasers, being sophisticated and expensive, add up to the total cost of the system and reduce its reliability.

Two technological progresses, i.e. the diode pump technology and the new laser materials, open up the way to a new generation of ultra rapid lasers delivering high performances, that are more compact, more reliable and less expensive than the present femtosecond lasers.

As far as the diode pump technology is concerned, the laser industry underwent a technological mutation during about a decade that can be compared to the replacement of vacuum tubes by semiconductors in the electronic industry. Any laser whatsoever obtains its power from an external energy source. Traditionally, this source of energy was a flash lamp or a vacuum tube, filled with an ionized gas. The increasing availability of semiconductor lasers (diode lasers) as sources of energy offers incredible advantages as far as size, life cycle and reliability are concerned. However, these new components cannot be used in Ti:Sapphire femtosecond lasers, due to the characteristics of Ti:Sapphire whose crystal does not have any absorption band in the laser diode wavelength range. The Ti:Sapphire laser cannot take advantage of the diode pumping revolution.

As far as the new laser materials are concerned, recent developments in the growth of laser crystals have resulted in a new generation of crystals, whereby Ytterbium is used as an active dopant, having an excellent optical quality and which are entirely compatible with high power laser diodes within the telecommunication category.

Another interesting geometry that makes use of the Ytterbium ion is Ytterbium-doped fiber. Indeed, large core fiber amplifiers provide for very interesting performances within the scope of the invention.

The direct pumping of Ytterbium-doped materials through diodes opens the way to a new generation of ultra rapid lasers with an improved compactness, reliability and cost-effectiveness.

The main advantages offered by this new-generation laser to the invention are treatment speed and industrial reliability.

As far as treatment speed is concerned, the present femtosecond lasers are restricted to some 1-5 kHz. The laser used within the scope of the present invention, however, has a minimum repetition level of 10 kHz to up to 1 MHz. This is immediately translated in a higher treatment speed, which is extremely important for the industrial productivity.

As far as industrial reliability is concerned, the present femtosecond lasers (Ti:Sa) comprise at least one intermediary nanosecond laser for the optical pumping, whereas the laser used in the method according to the invention does not require any additional lasers.

Another interesting advantage is that the laser diodes used for pumping the Ytterbium have an emission wavelength of about 980 nm, identical to the wavelength used in optical telecommunication applications. Thanks to the considerable developments that have been realized in this field, we now have an excellent high-power laser diode source that is highly reliable.

The quantal efficiency of the optical pumping is defined as the ratio between the pump wavelength and the laser wavelength. The greater the quantal efficiency, the less unwanted heat will be generated by the laser.

The following table compares the quantal efficiency of the present femtosecond lasers to that of femtosecond Ytterbium lasers.

| | Pump | Laser | Quantal |
|---|---|---|---|
| | Wavelength | Wavelength | Efficiency |
| Present fs | 532 nm | 800 nm | 65% |
| lasers | | | |
| Fs Ytterbium | 980 nm | 1030 nm | 95% |
| lasers | | | |

Thanks to this high quantal efficiency and the low quantity of heat being generated, Ytterbium lasers have a great potential to increase the repetition rate and the average strength.

Finally, compared to the present amplified femtosecond systems, given the small number of diodes being used in Ytterbium lasers, the required tension and current levels are low, which results in a low power supply being required, a low consumption of electricity, low replacement and usage costs.

Femtosecond lasers offer an interesting alternative as far as marking is concerned, thanks to their ultra short pulse length. Their extremely high optical density provides for a very efficient interaction with the sample to be marked, even in case of transparent materials. The ultra short pulse length prevents any thermal effects being produced during the interaction, which results in an excellent marking quality.

Ti:Sapphire femtosecond lasers have proven their aptitude to create waveguides for inside glass engraving for several years now.

Color changes have been shown in plastic, but they are not permanent in glass.

The method described in the present patent uses a new type of femtosecond laser source (diode-pumped) which makes it possible to achieve an industrial productivity and reliability with a special technique which makes it possible to directly provide permanent, high-contrast codes on the inside of transparent materials.

The method according to the invention creates visible or invisible codes and identifications which cannot be easily altered or erased and which are created on the inside of the material without adding any special compounds on the inside or on the product, and it allows for a marking at any depth whatsoever in the transparent material, for example on the inside of a glass substrate or in the middle of a 6 mm glass plate, and not only close to the surface, without creating any small structural internal changes such as micro-ablations or small bubbles due to the very rapid temperature increase or any scattered structures in the form of bleached parts, and without being restricted to certain materials or certain applications within the field of the marking of objects made of resins.

To this end, the invention concerns an internal laser marking method for transparent materials, for example to mark an identifier for an object made of a transparent material, characterized in that a diode-pumped femtosecond laser source is used for a non-aggressive high-contrast marking in order to generate laser pulses that are successively focused in different points of the mark to be realized and that make it possible to realize marks at high speed, typically at more than 0.1 mm² per second or better still more than 1 mm² per second.

The marking speeds obtained with the method according to the invention are entirely compatible with the capacities required in the industrial sector. For example, a femtosecond laser with an average power of less than 1 Watt makes it possible to engrave 2D codes of 16 lines×16 legible columns per camera in less than 0.05 sec.

Such a rate is typical for the traceability in view of the production control and the distribution circuit control of the pharmaceutical industry (production of 20 phials per second). Such typical rates can be obtained with the method according to the present invention by using a diode-pumped femtosecond laser, making use of a regenerative amplifier but not of any chirped pulse amplification, nor any parabolic amplification.

The use of such a laser source making use of a single regenerative amplifier and which does not use any chirped pulse amplification, nor any parabolic amplification, which both require a pulse compressor after the first amplification stage, allows for less complexity, more reliability and a more interesting price for the industrial sector than for example the laser source described in patent application US 2003/0156605.

The femtosecond laser source preferably provides for a modification of the refraction index of the transparent material in the focused points or in their periphery.

In this way, the present invention solves the problems related to the internal marking of transparent materials in a safe and reliable manner, with a new type of diode-pumped femtosecond laser sources and by changing the refraction index, opening the way to special designs and to high-resolution code marks.

It should be noted that the modification of the refraction index obtained with the method according to the invention differs from the diffractive effect represented in US patent 2005/0073748.

Indeed, the diffractive effect represented in US patent 2005/0073748 is explained by means of a modulation of the refraction index forming a Bragg network. The inventors experimentally show that the spatial distribution of the refraction index is formed of superimposed sinusoidal-type profiles in the cross direction X. This is interpreted by means of the simplified theory of coupled waves according to Kogelnik. The latter assumes and is only valid in case of a constant index modulation in the longitudinal direction Z. Besides, this theory is only applicable to Bragg networks in this case having a higher line density than the one that is currently produced with the method according to the present invention, i.e. a density of more than 500 lines/mm.

Diffractive index modulations obtained with the method according to the present invention, however, have a highly variable amplitude in the longitudinal direction (propagation direction of the beam or Z direction of patent 2005/0073748).

This divergence is reinforced in particular by the self-focalization of the laser beam which spatially modifies the index modulation in a non-linear manner in the focusing zone. Such a distribution of the index modulation is entirely different from the one represented in US patent 2005/0073748. Among others, it no longer forms a Bragg network and requires the use of precisely coupled wave models for its description. Moreover, these models show diffractive behavior that is entirely different from what is obtained with Bragg networks, such as multi-order diffraction. This is particularly true for spatial diffractive structures with a low frequency as those produced by the method according to the present invention.

Thus, the method according to the present invention differs completely from the method described in US patent application 2005/0073748A1. Given the method used in US 2005/0073748, the mentioned radiation times and speeds when using a laser having a power equivalent to that of the one described above (1 Watt) lead to 40-minute cycles for marking a 1 mm² code, and to 25-second cycles for marking a 0.01 mm² code. These values are incompatible with the applications aimed at in the present patent. Thanks to this method, the marking speeds are improved by a factor of more than 1500 for millimeter codes and of more than 500 for codes smaller than 100×100 μm.

The diode-pumped femtosecond laser preferably uses a rare earth-doped crystal, for example an Ytterbium-doped crystal, or it is a fiber laser, i.e. whose active core is a doped fiber.

The invention can be used in:
The decoration industry: the glass treatment time can be reduced to a few seconds, resulting in an interesting productivity for the perfume or beverage industry (wines, alcohol, . . . ) where millions of bottles are decorated each year, introducing innovating decoration concepts which can only be obtained with YAG lasers (ns pulses);
antifraud applications: it is possible to write individual codes in a reliable manner at a rate of more than 100 codes per second and to read these invisible high-contrast signatures with the same reliability by means of a low-priced viewing system on the production line as well as with new hand-held readers, and it is also possible to include ‘hidden’ data in complex decorations associated with suitable reading devices;
normative marking: it is possible to write normative references, independent of the glass quality, and that can be visually interpreted or read by means of simple viewing systems. Moreover, it is possible to introduce direct markings in the pharmaceutical, chemical and beverage industries, without modifying the mechanical qualities, i.e. without any micro cracks, in order to preserve the integrity of the glass;
the inside marking of a glass substrate, in particular flasks, perfume bottles, car windows, tempered plate glass;
the identification of data carriers such as CD's, DVD', etc. by making use of an identifier that can be inserted on the transparent part of the carrier (center of the disk) or in the packaging so as to guarantee the authenticity of the carrier, whereby the identifier may be a label, a code or a mix of both.

The method according to the invention makes it possible to fill the mark or the identifier with a diffractive structure, which is advantageous in that the trajectories of the light through the transparent object are modified, whereas the transparency of the object to be marked is not removed, as opposed to with a diffusing structure as can be seen for example in US patent 2004032566.

The device with which the method according to the present invention can be implemented comprises a diode-pumped femtosecond laser that is optimized for the high-production rates of the industry, whereby the latter comprises a regenerative femtosecond laser and does not make use of any chirped pulse amplification, as well as a device comprising such a laser, a galvanometric head, focusing optics and a control system.

For clarity's sake, the following embodiments of a device that can be used according to the invention are described by way of example only and without being limitative in any way, as well as the method according to the invention for the internal laser marking of transparent materials, with reference to the accompanying drawings, in which:

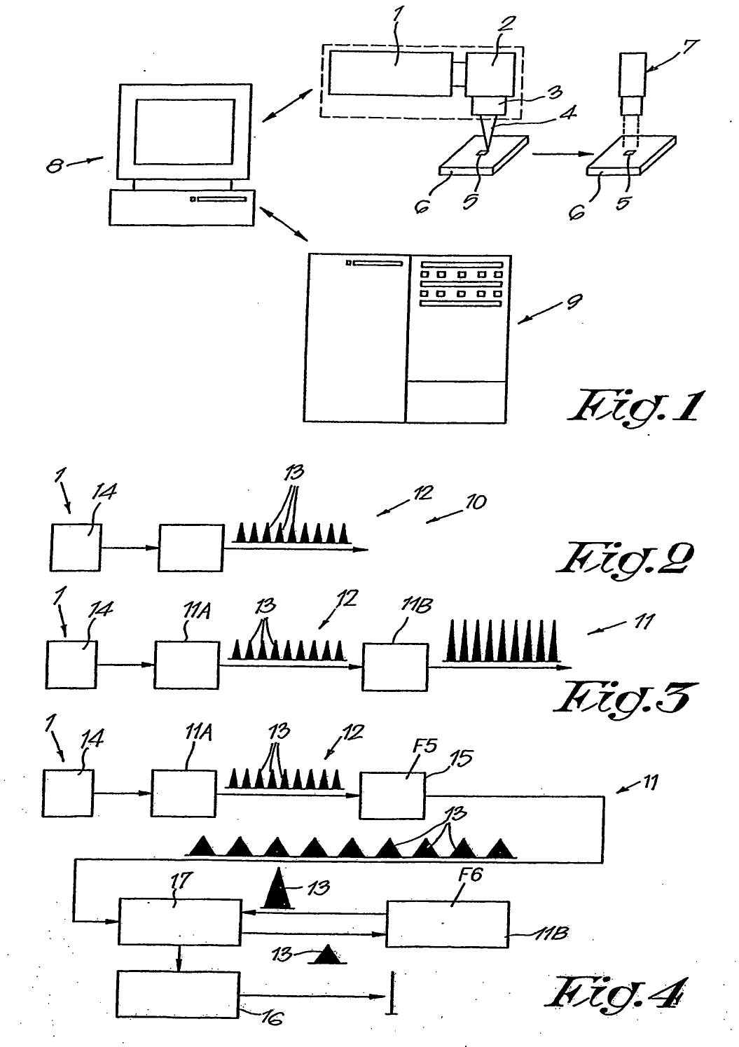

FIG. 1 is a schematic representation of a laser installation with a laser according to the invention allowing for the internal laser marking of a transparent object according to the method of the invention;

FIG. 2 represents a laser according to the invention;

FIGS. 3 and 4 represent variants of the lasers according to the invention;

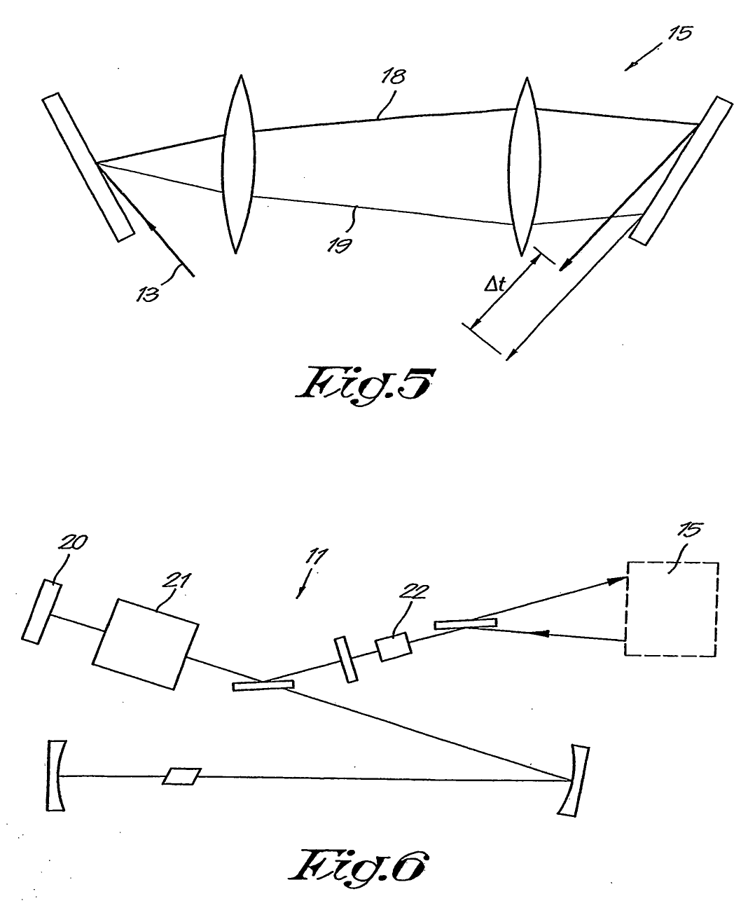

FIGS. 5 et 6 respectively represent the parts indicated by F5 and F6 in FIG. 4;

FIGS. 7 and 8 show two possible diffractive patterns for marking an object;

FIG. 9 shows examples of object identifiers;

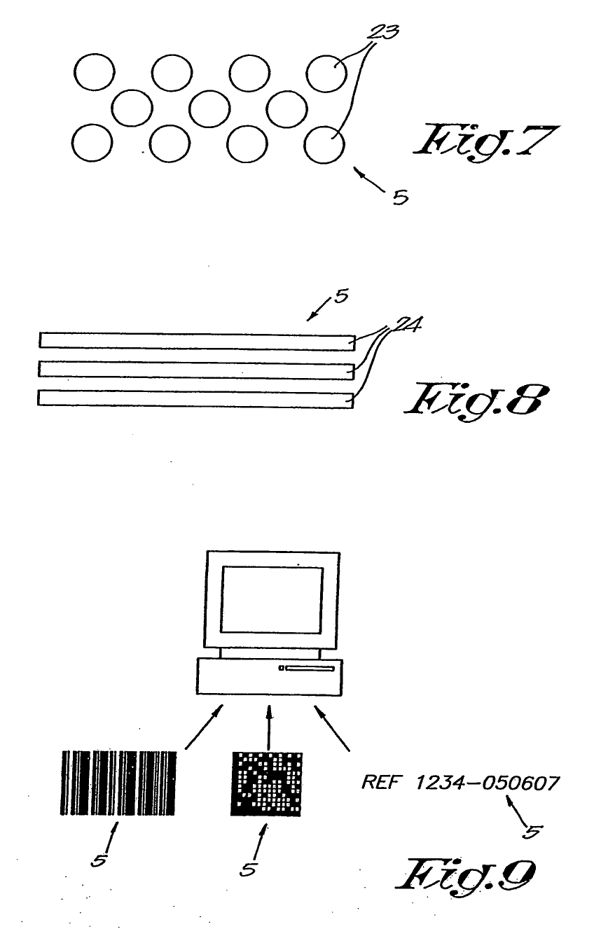

FIGS. 10 to 12 represent examples of anticounterfeit codes realized with the method according to the invention;

FIGS. 13 and 14 show two reading systems used to visualize marks realized with the method of the invention.

As represented in FIG. 1, the method of the invention makes use of a laser installation which comprises a diode-pumped femtosecond laser 1, a beam transportation system 2, for example a galvanometric head, an engraved design control system, and an optical focusing system 3 for the laser beam 4 which allows for very feeble aberrations. The mark 5 or design in the form of for example an identifier, code, logo, decoration, is engraved inside the transparent material 6 of the object to be marked without any micro crack being produced.

The reading system 7 will read the information comprised in the mark 5 or engraved code.

A femtosecond laser 1 is a pulsed laser, emitting very short light pulses. Each pulse has a very short length, typically in the order of ten to a few hundred femtoseconds (1 fs=10-¹⁵ sec).

The use of such short pulses for the marking offers two major advantages:
thanks to the very short pulse length, no thermal effect whatsoever is produced during the treatment, resulting in a high-quality mark, without any micro cracks being produced; and
thanks to the very high peak power of the pulses, the peak power being defined as the ratio between the energy of a pulse and its length, it is possible to realize a mark on or on the inside of transparent materials.

As represented in FIGS. 2 and 3, there are two methods to produce high-energy femtosecond pulses with a laser 1, i.e. by means of a femtosecond oscillator 10 or by means of a femtosecond amplifier 11.

A femtosecond oscillator laser 10 as represented in FIG. 2 typically produces a pulse 13 string 12 having very little energy in the order of nanoJoules, but having a very high frequency, typically between 10 MHz and 100 MHz. A femtosecond oscillator 10 comprises laser pump sources 14 and an active environment (crystal, glass, fiber), a resonator and an oscillating part 10A to generate femtosecond pulses 13. Such oscillators 10 may produce pulses having an energy of up to 500 nJ, which may be sufficient for some applications.

An amplifier laser 11 as represented in FIG. 3 is used if the energy of the pulse 13 is insufficient for a particular application and comprises an oscillating part 11A followed by an amplifying part 11B and allows for the amplification of the pulse. However, direct amplification of femtosecond pulses 13 is not always easy. During the amplification, the peak power of the amplified pulse may become strong enough to cause optical damages to the elements of the amplifier.

In that case, an amplifier 11 can be used based on what is called the Chirped Pulse Amplification or CPA technique, which is a well-known technique described for example in the article of Galvanauskas et al., Optics Letters 26, p. 935 (2001) and which is designed to reduce the peak power inside the amplifier. It is a three-stage method, illustrated in FIG. 4:
the length of the pulse 13 coming from the oscillating part 11A is increased in the pulse broadener 15, thus reducing the peak power of the pulse 13;
the pulse 13 is amplified in the amplifying part 11B without any damages being made thanks to the reduced peak power; and,
as soon as all the sensitive components have been passed, the length of the pulse 13 is restored to its initial value in a pulse compressor 16.

These typical amplifiers 11 may increase the pulse energy by 4 to 6 orders of magnitude. However, amplifying at such energy levels while maintaining a high repetition rate of the oscillating part 11A would result in moderate powers that cannot be controlled. Only one pulse 13 of the oscillating part 11A is selected by an optical switch 17 for the amplification, which results in the repetition rate being lowered. A typical scheme of an amplified femtosecond laser with chirped pulse amplification is illustrated in FIG. 4. The different generating stages of the femtosecond pulses by these types of lasers are:
the laser oscillator 11A delivers a succession of short, low-energy pulses 13;
the pulse length is increased in the pulse broadener 15;
the optical switch 16 extracts one unique pulse 13;
the pulse energy is increased in the amplifier 11B;
the optical switch 16 extracts the high-energy pulse from the amplifier 11B; and finally,
the length of the pulse is reduced in a pulse compressor 16.

In a typical configuration, both the oscillator 10 and the amplifier 11 use Ytterbium-doped materials and crystals as an active component. Alternative materials are Neodymium-doped or doped with other rare earths.

Similarly, the optical switch 17 is an optoelectronic switch which makes use of a Pockels cell. In alternative configurations, the optical switch 17 is an optoacoustic switch which makes use of an optoacoustic modulator.

Typical characteristics of the laser beam 4 generated by the amplifier 11 are:
the length of the pulse is inferior to 3 ps, for example 500 femtoseconds;
the pulse energy is higher than 1 μJ, for example 10 μJ;
a repetition rate of more than 10 kHz; and
a beam quality according to the TEM₀₀ standard.

The broadening of pulses is made easier by the fact that a femtosecond pulse has an intrinsically broad spectrum.

The pulse length ΔT and the width Δv of its spectrum are linked by the relation ΔT.Δv>k, where k is a constant depending on the temporary shape of the pulse.

FIG. 5 shows the working principle of a pulse broadener 15. The figure is merely given is an illustration, and it is not necessarily the real design as used in the system. In this figure, the pulse broadeners 15 comprise two diffraction networks, in which each spectral component of the femtosecond pulse 13 follows another optical path, 18 and 19 respectively.

The optical path 18 seen by a short wavelength, often called the ‘blue’ part of the spectrum, is longer than the optical path 19 seen by a larger wavelength, called the ‘red’ part of the spectrum. Thus, the ‘blue’ part is retarded in the pulse broadener 15.

At the output of the broadener 15, the different spectral components are subject to a drift.

Note that the terms ‘blue’ and ‘red’ should not be taken literally, the spectral width of the femtosecond pulses being in the order of a few nanometers, which does not at all cover the visible spectrum.

As represented in FIG. 6, the laser amplifier 11 is a regenerative amplifier which is composed of a laser resonator 20 in which a temporarily broadened pulse 13 coming from the oscillating part 11A propagates.

A commutation module 21 with a Pockels cell traps a unique pulse 13 coming from the oscillating part 11A in the amplifier 11. Said pulse 13 is then amplified by successive to-and-fro movements in the laser amplifier 15, as opposed to a simple amplifier in which there is only one pulse passage.

As soon as the amplified pulse has reached the desired energy level, it is extracted from the resonator by the same commutator 21 with the Pockels cell.

An optical routing device which makes use of a Faraday rotator 22 then sends the outgoing pulse into the pulse compressor 16.

The main advantages of regenerative amplification are a high amplification ratio (typically of more than 6 orders of magnitude), as well as an excellent beam quality (Gaussian beam TEM₀₀).

The pulse compressor 16 restores the amplified pulse length to its initial value. Its principle is similar to that of the pulse broadener 15, except that in this case, the ‘blue’, part of the spectrum sees a shorter optical path than the ‘red’ part.

Although the invention does not exclude the use of the chirped pulse amplification technique, this technique is preferably not used in order to avoid having to use a pulse broadener and/or a pulse compressor as is the case for example in US patent application 2003/0156605A1 where a laser source does not use any regenerative amplifier, but uses either the chirped pulse amplification or the parabolic amplification, which both require a compressor after the last amplification stage.

Indeed, the generation of high peak powers is limited due to the damages induced by the high power, and the use of chirped pulse amplification makes it possible to restrict said limitation, but it represents some disadvantages as far as the system design is concerned, i.e. the pulse broadener and the pulse compressor make the system more complex and moreover, the typical efficiency of a compressor is only in the order of 50 to 60%, which significantly reduces the total efficiency of the system.

Before any optical damages appear, the first restriction is caused by non-linear effects in the optical components of the amplifier. These effects, in particular the Self-Phase Modulation or SPM), lead to a spectral and spatial broadening of an ultra short optical pulse due to the temporary dependence of the non-linear phase shift, which results from the dependence of the intensity of the refraction index.

The Self-Phase Modulation is in proportion to the peak power of the pulse, and it is inversely proportional to the size of the beam in the optical components.

Thus, in a typical configuration, the used laser source 1 will be especially optimized for the internal high-speed marking, meaning that:
the energy per pulse 13 is sufficiently high so as to allow for an efficient marking, but sufficiently low so as not to make a pulse broadener 15 and a pulse compressor 16 indispensable;
the repetition rate is high (>100 kHz) in order to guarantee a high treatment speed; and,
the laser 1 is a diode-pumped femtosecond laser, and it benefits from all the advantages described in the preceding paragraphs.

In this configuration, the laser 1 comprises:
a femtosecond oscillator, delivering a succession of high-energy, short-length pulses at a high repetition rate;
a regenerative amplifier which uses an optical switch 17 to select a single pulse 13 coming from the oscillator, to send it into the amplifier, and to extract it from the latter as soon as the amplification has been completed; and,
an optical router to make sure that the pulse 13 coming from the oscillator and going into the amplifier, and the pulse coming from the amplifier do not follow the same path.

In this typical configuration, the amplifier directly accepts a pulse from the oscillator, i.e. a pulse that has not been temporarily extended in a pulse broadener 15.

The design of the amplified laser, allowing for a direct amplification without there being any need for a chirped pulse amplification, is based on three points:
minimizing the number of optical components in the optical path of the beam, as the only components that contribute significantly to the SPM are the Pockel cells and the laser crystal in the above-described embodiment;
minimizing the optical length of the system, for example by selecting components with a length that is as small as possible;
maximizing the size of the beam in the optical components.

These phases are not evident and require a special design: the reduction of the crystal length is compensated by the efficiency of the system, for example.

Thus, according to the invention, the laser 1 is a diode-pumped femtosecond laser which may be, depending on the application, an oscillator, an amplifier making use of a chirped pulse amplification, or an amplifier which does not use any chirped pulse amplification.

The method for the internal laser marking of transparent materials is illustrated in FIG. 1.

The mark 5 in the shape of a design or a code is provided by the control computer 8 or by means of an interface coupled to a database or an ERP 9 system.

The laser 1 fills the design (data matrix, serial number, logo) as represented in FIGS. 7 and 8, with a series of dots 23 or lines 24 respectively, or with repetitive forms or patterns, by focusing the beam 4 on the inside of the material 6, whereby the depth is selected by the operator or by the system itself thanks to a distance measuring device.

The dots 23 are defined by one or several laser pulses, the characteristics of the lines 24 are defined by the speed (at a fixed repetition rate) of the laser 1, i.e. by a number of pulses per line 24.

The distance between the dots 23 is controlled in order to obtain visible or invisible codes, but with a strong contrast for a reading or viewing system 7.

Depending on the wavelength and the angular diffraction required for the viewing system 7, one selects a pitch in the wavelength range spectrum of the viewing system which is typically situated between 0.5 and 10 μm. The marks or codes 5 can be controlled after having been treated by a viewing system 7, either or not with a special light. The marks 5 or codes can be read again by a fixed camera or a viewing system, or by a manual reader.

The effect of the laser pulse is a change in the local index, which makes it possible to create an internal diffractive structure.

The energy, the energy density and the number of pulses are optimized so as to obtain permanent marks or codes 5.

The spot size is situated between 1 and 10 μm, which allows for an extreme precision. A single dot 23 is invisible, but the whole of dots or lines and the repetitive pattern leads to an absorbing design or a diffractive structure.

In order to obtain a strong contrast, the dots 23 or lines 24 describe a repetitive pattern and are preferably separated by a distance between 0.5 and 10 μm. In this case, the light will be diffracted, the codes 5 will have different colors depending on the visual angle, and with the appropriate light, the codes will be very rich in contrast, i.e. of up to more than 75% (Grade A AIM).

The codes 5 may be so small that they are not visible to the eye without a microscope. The codes 5 may also be invisible in daylight, but visible at an appropriate wavelength with a viewing system 7 with a camera that is sensitive to this wavelength, providing an anti-fraud signature.

A 2D matrix of 16×16 should not be larger than 60×60 μm, providing an enormous number of data (16 alphanumerical characters −10²⁴ references) which can also be read.

The high frequency of the diode-pumped lasers makes it possible to create legible, permanent codes in less than 0.05 seconds, whereby the limitation is due to the calculation time of the computers.

Thus, one can engrave for example an identifier (5) in the form of a legible 2D data matrix with a size of less than 0.4×0.4 mm in less than 0.2 seconds.

As represented in FIG. 9, the engraved marks 5 may be logos, texts, serial numbers, 2D matrixes, for example Data matrixes, barcodes, special anti-fraud codes such as Kezzler codes, or a mix of decoration and codes.

The code can be automatically increased by increments by the system or it can be linked to an external control system which allows for a data management. The decoded information may provide information that can be directly used, for example a maturity date, or that can be used by interrogating the internal database of a company or centralized general databank for anti-counterfeit codes.

The codes may have dimensions of only a few tens of microns. They may be very rich in contrast, for example between 60 and 80% Grade A AIM for a viewing system.

The extremely high precision of the method provides for different security levels: a visible normative code and an invisible data matrix can be marked simultaneously.

As represented in FIG. 10, a visible code 25 provided by a method according to the invention may comprise other information meant for anti-fraud investigations, for example by using a pixel 26 of the normative code as a data matrix code that can only be read with an appropriate viewing system (optical investigation) or by using available and non-used bits of the code (investigation whereby use is made of a dedicated deciphering software).

Anti-fraud data matrixes 25 may be inserted in a logo, for example, or they may form an integral part of a trade name or a registered trade mark. In the example of FIG. 11, the code 27 is invisible and hidden in the decoration, for example as contained within the dot on the ‘i’ 28 of the logo ‘Identifier’ 29.

Codes or logos may have surprising effects. They may for example be invisible save from one visual angle, change color as a function of the visual angle or be only visible under the appropriate light. For even more security, the visual angle from which the identifier can be read can be clearly modified.

The information contained in a data matrix can be a Kezzler code in the form of a set of 16 alphanumerical characters, providing optical and numerical (via software) anti-fraud protection.

The information contained in a data matrix can be read by means of a standard reader and it may also comprise some hidden information for a standard reader thanks to some non-used bits of the data matrix, whereby the hidden information can only be read in combination with an appropriate software key.

The counterfeit aspect can be obtained thanks to the presence of the logo or the brand, the aesthetical aspect of the identifier, the encryption, the visible or invisible information, either or not linked to a special deciphering software, or a mix of these techniques resulting in a copy that is not economically feasible.

The (visible) normative code may contain different levels of information, for example, the reading of the code from FIG. 12 delivers the code 050904-33245656-3-4 which contains:
data meant for the end user, a maturity date, for example 4 Sep. 2005 (050904);
data meant for the production management. 33245656 may be an individual code or a serial number linked to a databank which makes it possible to control the different parameters used for the production of the marked product;
data (3-4) for the counterfeit investigation, which can be directly used by the experts either by means of appropriate software, or as it defines the position x=3, y=4 of an invisible antifraud code, realized with the same method and meant for counterfeit control or distribution circuit management.

As the identifiers 5 can be made at different depths, it is possible to provide several codes, but at different depths, making it almost impossible to remove them.

An example of a reading system 7 is represented in FIGS. 13 and 14. It comprises a camera 30, an objective 31 and a light 32.

The best way for reading absorbing engraved codes is by means of a light 32 in a clear field against a clear background 33 (white field) as represented in FIG. 13, and the best way for reading diffractive codes 5 is by means of a light 32 against a dark background 34 (dark field) as represented in FIG. 14.

It is possible to use fixed or manual reading systems or viewing systems 7. The codes 5 can also be detected by means of a Webcam and subsequently analyzed by means of viewing software.

The reading can be done on line in order to verify the engraved codes 5 in whatever production stage or in a laboratory for a future investigation of the product.

Thanks to the method according to the invention, it is possible to achieve a contrast of 75% (grade A—AIM: Automatic Identification Manufacturers, standard for the data matrixes defined in ISO/IEC18022).

The code may be a special set of alphanumerical characters, being referred to in a database.

It is clear that the invention is by no means restricted to the above-described examples, and that numerous modifications can be made to the method and to the laser described above while still remaining within the scope of the invention as defined in the following claims.

1. Internal laser marking method for transparent materials, comprising using a diode-pumped femtosecond laser source to generate laser pulses that are successively focused in different points of an area of the transparent material to be marked for creating a non-aggressive high-contrast marking.

2. Method according to claim 1, wherein the used laser source enables a marking speed of more than 1 mm² per second.

3. Method according to claim 1, including using an Ytterbium-doped crystal in the diode-pumped femtosecond laser.

4. Method according to claim 1, wherein the diode-pumped femtosecond laser is a fiber laser.

5. Method according to claim 1, wherein the diode-pumped femtosecond laser is a femtosecond oscillator.

6. Method according to claim 1, wherein the diode-pumped femtosecond laser is a femtosecond amplifier.

7. Method according to claim 1, wherein the diode-pumped femtosecond laser is a regenerative femtosecond amplifier.

8. Method according to claim 1, wherein the diode-pumped femtosecond laser is a regenerative femtosecond amplifier and does not use any chirped pulse amplification.

9. Method according to claim 1, wherein the diode-pumped femtosecond laser has a repetition rate of more than 10 kHz.

10. Method according to claim 1, wherein the diode-pumped femtosecond laser has a pulse length of less than 3 ps.

11. Method according to claim 1, wherein the diode-pumped femtosecond laser has an energy per pulse of more than 3 μJ.

12. Method according to claim 1, wherein the marking is so small so as to be invisible to the naked eye.

13. Method according to claim 1, wherein the marking is readable by means of a standard reading system or viewing system.

14. Method according to claim 1, wherein the marking is smaller than 60×60 μm.

15. Method according to claim 1, wherein the marking is engraved in less than 0.05 seconds.

16. Method according to claim 1, wherein the marking is made in less than 0.2 seconds.

17. Method according to claim 1, wherein the marking has contrast of 70% (grade A—AIM).

18. Method according to claim 1, wherein the femtosecond laser pulse creates a local modification of the refraction index of the transparent material.

19. Method according to claim 18, wherein the index modulations created by the method have a strongly varying amplitude in a longitudinal direction, namely in the direction of propagation of the laser pulses.

20. Method according to claim 1, including filling of the marking with a diffractive structure.

21. Method according to claim 1, including filling the marking with repetitive forms or patterns.

22. Method according to claim 1, wherein the marking is filled with lines or dots that are mutually separated by a distance in the order of the wavelength spectrum of a reader.

23. Method according to claim 1, wherein the marking comprises a normative part and an antifraud part.

24. Method according to claim 1, wherein the marking comprises a decorative design.

25. Method according to claim 1, wherein the marking is an identification code, and a few bits of the identification codes define the position of an invisible antifraud code.

26. Method according to claim 1, wherein the transparent material is glass and the marking is formed on the inside of the glass material.

27. Method according to claim 1, wherein the transparent material is glass flasks and the marking is marked inside the flasks.

28. Method according to claim 1, wherein the transparent material is perfume bottles and the marking is marked inside the perfume bottles.

29. Method according to claim 1, wherein the transparent material is car windows and the marking is formed in the car window.

30. Method according to claim 1, wherein the transparent material is a tempered glass pane, and the marking is formed in the tempered glass pane.

31. Method according to claim 1, wherein the marking is integrated so as to form an integral part of a trade name or a registered trade mark.

32. Method according to claim 1, wherein more than one marking is provided next to another one, but at different depths.

33. Method according to claim 1, wherein the visual angle from where the identifier can be read can be clearly modified so as to further increase the security.

34. Method according to claim 1, wherein the identifier is provided inside a data carrier or inside a packaging for the data carrier.

35. Device for the internal marking of transparent materials, comprising a diode-pumped femtosecond laser comprising a regenerative femtosecond laser and which does not use any chirped pulse amplification; a galvanometric head; focusing optics and a control system.

36. Device according to claim 35, wherein the laser is a diode-pumped femtosecond laser with a repetition rate of more than 10 kHz and pulse energies comprised between 1 and 100 μJ.

37. Device according to claim 36, including a viewing system for verifying the marking information and an appropriate light.

38. Code comprising a marking made according to the method of claim 1 for preventing counterfeiting.

39. Code comprising a marking made according to the method of claim 1, for controlling distribution circuits.
